(19) United States
(12) Patent Application Publication
(10) Pub. No.: US 2007/0025870 A1
(43) Pub. Date: Feb. 1, 2007

(54) Eccentric pump, and use thereof

(75) Inventors: Johannes Deichmann, Alheim-Sterkelshausen (DE); Dirk Endler, Schenklengsfeld (DE)

Correspondence Address: MAYER, BROWN, ROWE & MAW LLP, P.O. BOX 2828, CHICAGO, IL, 60690-2828, US

(73) Assignee: SIEMENS AKTIENGESELLSCHAFT, Munchen (DE)

(21) Appl. No.: 10/568,925

(22) PCT Filed: Jul. 14, 2004
(86) PCT No.: PCT/EP04/51486

§ 371 Date: Apr. 13, 2006

(30) Foreign Application Priority Data
Aug. 27, 2003 (DE) 103 39 765.5

(51) Int. Cl. F01C 19/02; F01C 19/00; F03C 2/00; F04C 15/00; F04C 27/00; F03C 4/00

(52) U.S. Cl. 418/112; 418/140; 418/145

(57) ABSTRACT

Disclosed is an eccentric pump comprising an interior rotor (2) that is connected in a torsion-proof manner to an eccentric rotor (3) located in a housing (1) via a locking member (14). Said locking member (14) separates an area that is connected to an inlet duct (8) from an area which is connected to an outlet duct (9) in a pump chamber (12). The inventive eccentric pump requires an exceptionally small number of parts and can be produced in a particularly inexpensive manner.

The invention relates to an eccentric pump with an interior rotor arranged eccentrically in a housing, for feeding a medium from an inlet duct to an outlet duct. The invention furthermore relates to an advantageous use of the eccentric pump.

Eccentric pumps of this type are designed, for example, as gerotor pumps and are frequently used in practice in order to produce high feed pressures.

Disadvantages of the known gerotor pump include the fact that it is expensive to produce and requires a large number of parts. Furthermore, the known gerotor pump calls for exacting requirements to be placed on the accuracy and the material of the interior rotor and of the housing.

The invention is based on the problem of designing an eccentric pump of the type mentioned at the beginning in such a manner that it can be produced in a particularly inexpensive manner. Furthermore, an advantageous use of the eccentric pump is to be ascertained.

The problem mentioned first is solved according to the invention in that a recess of the housing is formed cylindrically for the rotatable holding of an annular eccentric rotor, in that a locking member seals the interior rotor from the exterior rotor at one point in a radially movable manner, in that the inlet duct, as seen in the direction of rotation of the interior rotor, is arranged behind the locking member and the outlet duct is arranged in the direction of rotation in front of the locking member, and in that the interior rotor, in an alignment with the housing, is opposite the eccentric rotor in a sealing manner.

By means of this design, a sickle-shaped pump chamber is produced between the interior rotor and the eccentric rotor, said pump chamber remaining at one point in the housing during rotation of the interior rotor. The locking member moves together with the eccentric rotor and the interior rotor and consequently moves through the sickle-shaped pump chamber during the rotation of the interior rotor relative to the housing. In the process, the space bounded by the interior rotor and the eccentric rotor is enlarged on the inlet duct side and the space is reduced on the outlet duct side. By this means, the medium to be fed is sucked through the inlet duct during a revolution into the sickle-shaped pump chamber and is subsequently pushed out during the next revolution through the outlet duct. The eccentric pump according to the invention does not need any further parts. Furthermore, the eccentric pump according to the invention does not require any complicated controls for the movements of the interior rotor or of the exterior rotor. The eccentric pump according to the invention can be produced in a particularly inexpensive manner. An electric motor for driving the feed pump according to the invention can be directly connected to the eccentric rotor or the interior rotor.

The outlet duct could be arranged, for example, on the interior rotor. However, in this case the medium to be fed would be fed counter to the centrifugal force. According to an advantageous development of the invention, the eccentric pump according to the invention is particularly highly efficient if the inlet is arranged in the center in the interior rotor and the outlet is arranged as an annular groove on the outside of the eccentric rotor and/or housing.

In the case of a rotating interior rotor, the inlet duct could be connected to the pump chamber via a hole or groove arranged in the housing and a duct arranged in the interior rotor. The eccentric pump according to the invention thereby turns out to be particularly compact. According to another advantageous development of the invention, the sealing of the inlet area from the outlet area turns out to be particularly compact if the locking member protrudes into the interior rotor.

The efficiency of the eccentric pump according to the invention is further increased in the case of a driven interior rotor if the inlet duct extends from the center of the interior rotor as far as its radially outer boundary in the vicinity of the area of the locking member. By this means, the feeding of the medium is assisted by the centrifugal force.

The locking member could be arranged, for example, on the interior rotor while the eccentric rotor requires a groove for accommodating the locking body. By this means, the eccentric rotor could be produced in a particularly inexpensive manner as a turned part with radial recesses. However, according to another advantageous development of the invention, the eccentric rotor can be produced with high stability and a compact construction if the locking body is arranged on the eccentric rotor and the interior rotor has a recess for accommodating the locking body.

The number of parts of the eccentric pump according to the invention is further reduced, according to another advantageous development of the invention, if the locking body is manufactured integrally with the eccentric rotor or the interior rotor.

According to another advantageous development of the invention, wear of the locking member in the groove can be kept particularly low if the locking body has a radius or curve bearing against a sealing surface arranged in the recess of the opposite part.

According to another advantageous development of the invention, the wear of the locking member is further reduced if the locking member has a surface with high wear resistance in its area bearing against the sealing surface.

The problem mentioned second, namely the ascertaining of a particularly advantageous use of the eccentric pump, is solved according to the invention by the use for feeding fuel in a motor vehicle.

The invention permits numerous embodiments. To further clarify its basic principle, one of these is illustrated in the drawing and is described below. In the drawing

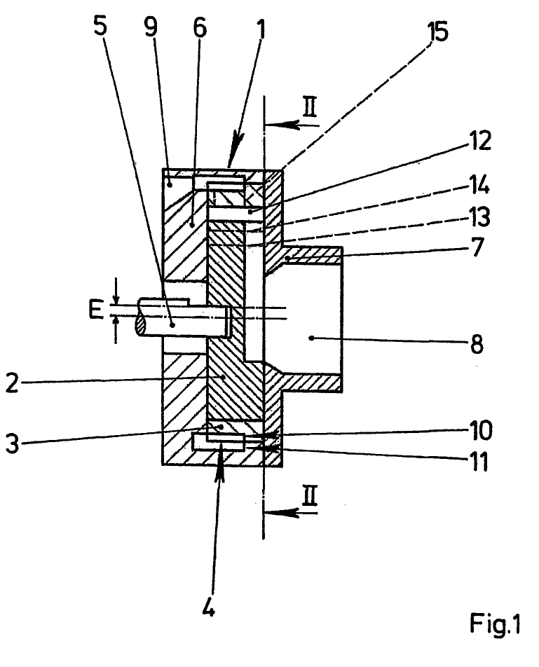

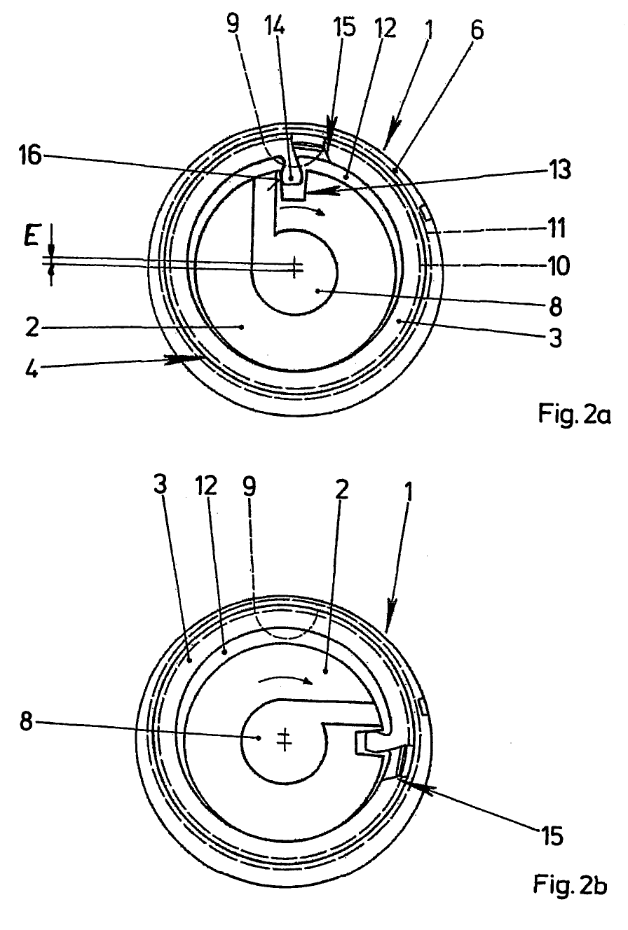

FIG. 1 shows a sectional illustration through an eccentric pump according to the invention,

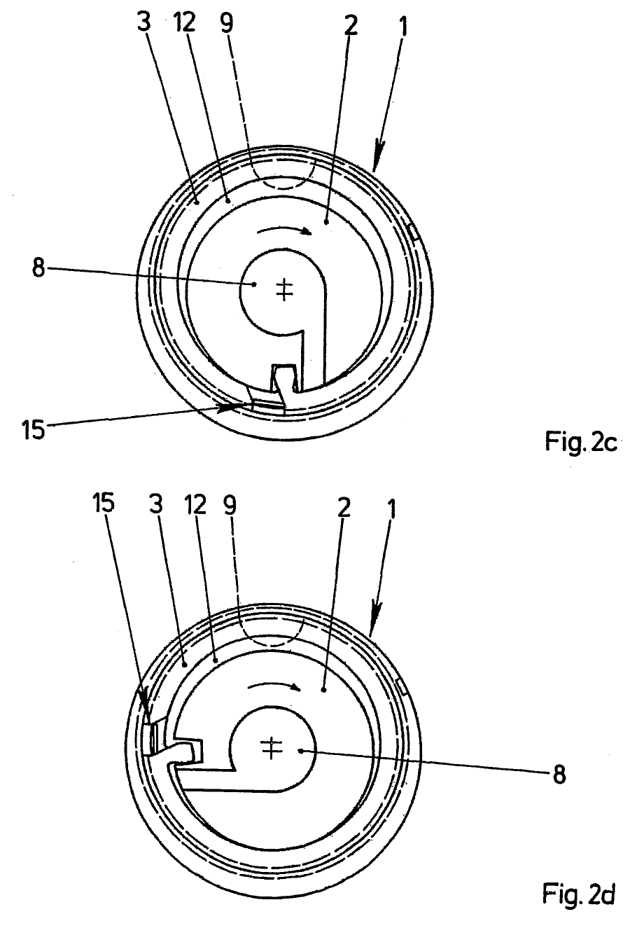

FIGS. 2a-2d show sectional illustrations through the eccentric pump from FIG. 1 with different positions of the interior rotor.

FIG. 1 shows an eccentric pump with an interior rotor 2 which is rotatable in a housing 1 and with an eccentric rotor 3. The axis of rotation of the interior rotor 2 is offset by the amount “E” in relation to the axis of symmetry of a cylindrical, inner recess 4 of the housing 1. The interior rotor 2 is connected in a torsion-proof manner to a drive shaft 5 and to the eccentric rotor 3. The eccentric rotor 3 slides in the inner recess 4 of the housing 1. The housing 1 has two housing parts 6, 7. An inlet duct 8 is arranged in one of the housing parts 7 while the other housing part 6 has an outlet duct 9. The outlet duct 9 is connected to annular grooves 10, 11 arranged in the housing 1 and the eccentric rotor 3.

A pump chamber 12 is situated between the eccentric rotor 3 and the interior rotor 2. Furthermore, the eccentric rotor 3 has a locking member 14 penetrating a recess 13 of the interior rotor 2. The eccentric rotor 3 has a duct 15 for connecting the pump chamber 12 to the annular grooves 10, 11 and therefore to the outlet duct 9. The inlet duct 8 is guided from the one housing part 6 to the center of the interior rotor 2 and subsequently radially outward as far as the pump chamber 12.

FIG. 2a shows the eccentric pump from FIG. 1 in a position of the interior rotor 2, and therefore of the eccentric rotor 3, in which the pump chamber 12 is divided centrally by the locking member 14. The locking member 14 bears with a rounded portion against a sealing surface 16 of the recess 13. The locking member 14 and the sealing surface 16 seal a delivery side of the pump chamber 12 from an intake side. Furthermore, the locking member 14 serves as a carry-along means for the rotationally fixed connection of the eccentric rotor 3 to the interior rotor 2. The pump chamber 12 is formed in an essentially sickle-shaped manner. The interior 2 and the eccentric rotor 3 roll and slide on each other in relation to the pump chamber 12 and seal the ends of the sickle-shaped pump chamber 12 from each other. The interior rotor 2 rotates in the clockwise direction while the housing 1 is fixed. The inlet duct 8 opens, as seen in the direction of rotation of the interior rotor 2, directly behind the locking member 14 into the pump chamber 12. The duct 15 of the eccentric rotor 3, which duct leads to the outlet duct 9, is connected, as seen in the direction of rotation, to the pump chamber 12 in front of the locking member 14.

FIG. 2b shows the eccentric pump from FIG. 2a after a rotation of the interior rotation 2 in relation to the housing 1 by 90° in the clockwise direction. A comparison with the position of the interior rotor 2 from FIG. 2a reveals that that part of the pump chamber 12 which is close to the duct 15 has been reduced in size while that part of the pump chamber 12 which is connected to the inlet duct 8 is enlarged. By this means, the medium to be fed has been sucked via the inlet duct 8 into the pump chamber 12. At the same time, a quantity of medium has been displaced out of the pump chamber 12 via the outlet duct 9. The quantities which are sucked up and displaced during a revolution are the same.

FIG. 2c shows the eccentric pump from FIG. 2b after further rotation of the interior rotor 2 in the clockwise direction. In this position, the inlet duct 8 and the outlet duct 9 are connected to the pump chamber 12. In this position, there are losses due to slippage, since the outer points of the pump sickle 12 inherently cannot be completely closed over a residual angle of rotation.

Upon further rotation of the interior rotor 2 according to FIG. 2d, the medium situated in the sickle-shaped pump chamber 12 is displaced into the outlet duct 9.

1. An eccentric pump with an interior rotor which is arranged eccentrically in a housing for feeding a medium from an inlet duct to an outlet duct, characterized in that a recess (4) of the housing (1) is formed cylindrically for the rotatable holding of an annular eccentric rotor (3), in that a locking member (14) seals the interior rotor (2) from the exterior rotor (3) at one point in a radially movable manner, in that the inlet duct (8), as seen in the direction of rotation of the interior rotor (2), is arranged behind the locking member (14) and the outlet duct (9) is arranged in the direction of rotation in front of the locking member (14), and in that the interior rotor (2), in an alignment with the housing (1), is opposite the eccentric rotor (3) in a sealing manner.

2. The eccentric pump as claimed in claim 1, characterized in that the eccentric rotor (3), as seen in its direction of rotation, has a duct (15) in front of the locking member (14), and in that the housing (1) and/or the outer side of the eccentric rotor (3) has/have an encircling annular groove (10, 11) connected to the duct (15) and to the outlet duct (9).

3. The eccentric pump as claimed in claim 1 or 2, characterized in that the inlet duct (8) is arranged in the interior rotor (2).

4. The eccentric pump as claimed in at least one of the preceding claims, characterized in that the inlet duct (8) extends from the center of the interior rotor (2) as far as its radial outer boundary in the vicinity of the area of the locking member (14).

5. The eccentric pump as claimed in at least one of the preceding claims, characterized in that the locking member (14) is arranged on the inside of the eccentric rotor (3) and the interior rotor (2) has a recess (13) for accommodating the locking body (14).

6. The eccentric pump as claimed in at least one of the preceding claims, characterized in that the locking member (14) is produced integrally with the eccentric rotor (3) or the interior rotor (2).

7. The eccentric pump as claimed in at least one of the preceding claims, characterized in that the locking member (14) has a radius or any other wear-favorable curve bearing against a sealing surface (16) arranged in the recess (13) of the opposite part.

8. The eccentric pump as claimed in at least one of the preceding claims, characterized in that the locking member (14) has a surface with high wear resistance in its area bearing against the sealing surface (16).

9. Use of the eccentric pump as claimed in one of the preceding claims for feeding fuel in a motor vehicle.
